(19) United States
(12) Patent Application Publication
(10) Pub. No.: US 2019/0303182 A1
(43) Pub. Date: Oct. 3, 2019

(54) SYSTEM AND METHOD FOR PROVIDING ADVICE AND ASSISTANCE THROUGH TASK-TRACKING SYSTEMS

(71) Applicant: Sears Brands, L.L.C., Hoffman Estates, IL (US)

(72) Inventors: James William Pier, Streamwood, IL (US); Eui Chung, Huntley, IL (US); Robert Edward Baumgardner, McHenry, IL (US); Edward S. Lampert, Bay Harbor, FL (US)

(21) Appl. No.: 16/366,945

(22) Filed: Mar. 27, 2019

Related U.S. Application Data
(60) Provisional application No. 62/648,881, filed on Mar. 27, 2018.

(51) Int. Cl. G06F 9/451; G06F 9/54; G06F 3/0482; G06N 20/00; H04L 12/18

(52) U.S. Cl. CPC G06F 9/453; G06F 9/546; H04L 12/1859; G06F 9/542; G06N 20/00; G06F 3/0482

(57) ABSTRACT

Systems and methods for providing advice and assistance to task-tracking systems are provided. In an embodiment, an application on a mobile device may receive information indicative of one or more user tasks, receive one or more task-completion suggestions from a personal and/or automated assistant reviewing the one or more user tasks, and send a notification to the user indicative of the task-completion suggestion. Task-completion suggestions include assistance information such as a reminder, advice, purchase options, and informative articles. Assistance information may be based on one or more of a type of task, user information, user feedback, task location, and a priority designation. User tasks may be entered manually entered and/or imported into an application of the present invention. In an embodiment, third-party applications may assist in task creation, research assistance, and task-suggestion notifications.

### BACKGROUND

Task tracking methods have long existed, and have historically utilized traditional paper systems. More recently, software systems and mobile applications have been created to accomplish similar tasks, namely recording, organizing, and tracking tasks.

While many assistance systems and applications exist, these systems are often designed around the user creating a request, submitting the request to helpers, then receiving offers to complete the task-usually with some monetary or credit system to pay for the system. In these request-based systems, the methods only start when the user creates a specific request, such as filling out a detailed form.

In another task system, a user can input tasks, including any additional details such as notes, deadlines, lists, images, etc. The task system then assists the user with organizing, reminding, and generally self-managing the tasks. Users expect to self-complete the task and mark the task manually within the system when completed.

In yet another existing assistance system, users make an explicit request for help. The request is sent to a service provider, who then offers options or provides services to complete the requests. Requests may be for information, manual tasks, service providers or any other service. The assistance starts with the user making an explicit request for assistance, and generally only includes information that has been provided within the request, the users system profile, or input through additional forms within the assistance system.

While these existing systems assist in aspects of task-management, they provide no assistance in utilizing the wealth of available user and task information to improve task-completion. A combination of task-management and task-completion assistance would provide a unique utility to users, improving both productivity and efficiency as users go about their daily task management.

### SUMMARY

The present disclosure generally relates to task management systems, and the combination of traditional task management systems with assistance applications. In various embodiments, users can provide details of tasks they wish to complete, and the system provides recording, detailing, organizing, and tracking of tasks.

The present invention takes task data and creates a system and method for providing targeted assistance in actually completing the indicated task. Task-completion assistance will be provided through a combination of automation, systems and human-intervention. The system may consist of websites, mobile applications, desktop software, and the necessary backend computer systems to support the entire invention, plus the methods and workforce necessary to manage the task assistance.

In an embodiment, users may import and/or manually enter tasks into an application of the present invention. The application may queue tasks, based on one or more factors, such as priority, time, location, etc. The tasks are communicated to assistants, which may be personal and/or automated, that provide one or more suggestions to complete the tasks. The application compiles suggestions and presents them to the user, who may use the suggestion, skip the suggestion, and/or provide feedback about the task suggestion. Task-suggestion notifications may be communicated to the user, and indicate various for the user to accomplish the task.

In an embodiment, present methods and systems utilize third-party applications to accomplish one or more aspects of the task suggestion and assistance determinations. For example, third-party applications may assist in task creation, research assistance, and task-suggestion notifications.

### BRIEF DESCRIPTION OF THE DRAWINGS

FIG. 1 a block diagram of an example general-purpose computing environment in which embodiments of the invention may be implemented.

FIG. 2 illustrates an example of providing task management assistance.

FIG. 3 illustrates an example embodiment utilizing third-party applications in accordance with aspects of the present invention.

FIG. 4 illustrates another example of providing task management assistance.

FIG. 5 is a schematic diagram illustrating an example cloud-based server that may be used in accordance with aspects of the present invention.

### DETAILED DESCRIPTION OF ILLUSTRATIVE EMBODIMENTS

Various aspects of the present disclosure described herein are generally directed to systems, methods, and computer-readable storage media for, among other things, providing advice and assistance through task-tracking systems. In the present systems and methods, normal task inputs may be combined with additional information known about the user to provide assistance options for completing the tasks. Unique from prior systems, the present invention tracks and combines daily tasks to provide proactive assistance in completing tasks.

In an embodiment, users can input daily tasks into software, an application, e.g., mobile phone application, or other third-party system to add tasks, provide details, and organize tasks. The present invention provides systems and methods for taking users' daily task information and combining the task information with additional information from other sources to provide assistance to the user to complete the daily tasks. The additional information may be prior user information or task information, for example, and may be gathered from one or more sources and/or applications, e.g., third-party providers, the Shop Your Way rewards system, or in-store purchase history. Task-completion assistance may include many different forms, including but not limited to information, research, manual task completion, reminders, organizational assistance, advice, product suggestions, product purchase assistance, or many other forms of assistance to the user. In addition, the assistance may be provided by the management and employees of the system, for example, or provided by third-party integration partners. Accordingly, the present invention uniquely tracks and combines tasks to proactively assist in task completion.

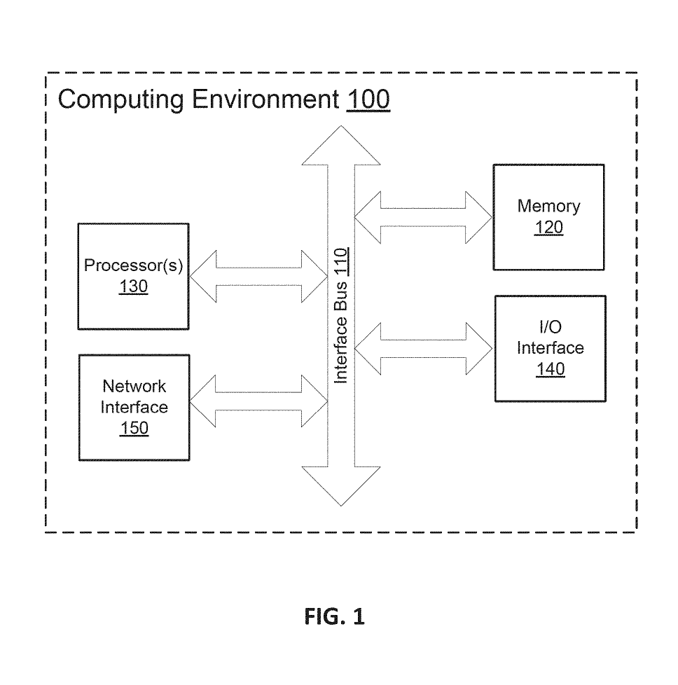

In FIG. 1, an example of a computing environment suitable for implementing embodiments of the present invention is described below. Referring to the figures generally and initially to FIG. 1 in particular, an exemplary computing environment in which embodiments of the present invention is depicted and generally referenced as computing environment 100. As utilized herein, the phrase “computing system” generally refers to a dedicated computing device with processing power and storage memory, which supports operating software that underlies the execution of software, applications, and computer programs thereon. As used herein, an application is a small in storage size, specialized program that is downloaded to the computing system or device. In some cases, the application is downloaded from an “App Store” such as APPLE's APP STORE or GOOGLE's ANDROID MARKET.

After download, the application is generally installed on the computer system or computing device. As shown by FIG. 1, computing environment 100 includes bus 60 that directly or indirectly couples the following components: memory 120, one or more processors 130, I/O interface 140, and network interface 150. Bus 110 is configured to communicate, transmit, and transfer data, controls, and commands between the various components of computing environment 100.

Computing environment 100 typically includes a variety of computer-readable media. Computer-readable media can be any available media that is accessible by computing environment 100 and includes both volatile and nonvolatile media, removable and non-removable media. Computer-readable media may comprise both computer storage media and communication media. Computer storage media does not comprise, and in fact explicitly excludes, signals per se.

Computer storage media includes volatile and nonvolatile, removable and non-removable, tangible and non-transient media, implemented in any method or technology for storage of information such as computer-readable instructions, data structures, program modules or other data. Computer storage media includes RAM; ROM; EE-PROM; flash memory or other memory technology; CD-ROMs; DVDs or other optical disk storage; magnetic cassettes, magnetic tape, magnetic disk storage or other magnetic storage devices; or other mediums or computer storage devices which can be used to store the desired information and which can be accessed by computing environment 100.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media, such as a wired network or direct-wired connection, and wireless media, such as acoustic, RF, infrared and other wireless media. Combinations of any of the above should also be included within the scope of computer-readable media.

Memory 120 includes computer-storage media in the form of volatile and/or nonvolatile memory. The memory may be removable, non-removable, or a combination thereof. Memory 120 may be implemented using hardware devices such as solid-state memory, hard drives, optical-disc drives, and the like. Computing environment 100 also includes one or more processors 130 that read data from various entities such as memory 120, I/O interface 140, and network interface 150.

I/O interface 140 enables computing environment 100 to communicate with different input devices and output devices. Examples of input devices include a keyboard, a pointing device, a touchpad, a touchscreen, a scanner, a microphone, a joystick, and the like. Examples of output devices include a display device, an audio device (e.g. speakers, a printer, and the like. These and other I/O devices are often connected to processor 130 through a serial port interface that is coupled to the system bus, but may be connected by other interfaces, such as a parallel port, game port, or universal serial bus (USB. A display device can also be connected to the system bus via an interface, such as a video adapter, which can be part of, or connected to, a graphics processor unit. I/O interface 140 is configured to coordinate I/O traffic between memory 120, the one or more processors 130, network interface 150, and any combination of input devices and/or output devices.

Network interface 150 enables computing environment 100 to exchange data with other computing devices via any suitable network. In a networked environment, program modules depicted relative to computing environment 100, or portions thereof, may be stored in a remote memory storage device accessible via network interface 150. It will be appreciated that the network connections shown are exemplary and other means of establishing a communications link between the computers may be used.

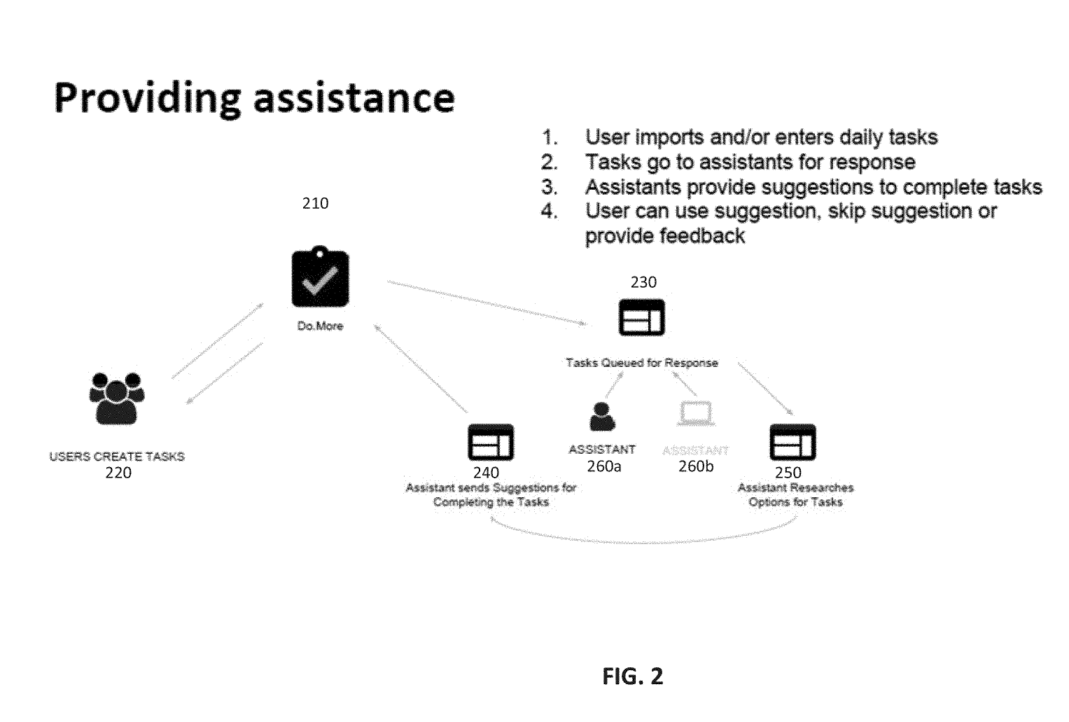

FIG. 2 illustrates an example of providing task-completion assistance in accordance with an embodiment of the present invention. Users create and/or import tasks 220 into an application, such as the depicted Do.More application 210. Tasks may be created, for example, by manually entering information, importing from one or more applications, or automatically, e.g., a recurring task. Tasks are queued 230 in preparation for communicating with assistants 260a 260b, to provide suggestions for completing tasks. Tasks may be queued based on indicated priority, time, date, or other designated indication, which may be entered by the user, or based on prior tasks and/or information received from one or more sources.

Assistants may be an individual 260a reviewing tasks to refine the queued tasks and offer completion suggestions. An assistant may also be an automated assistant 260b that can provide suggestions to complete tasks. Suggestions can include for example, an order in which to complete the tasks and/or reminders to complete the tasks. The personal assistant 260a and automated assistant 260b may work individually, or in conjunction to provide task suggestions. For example, assistant 260a may review the task completion suggestions from assistant 260b, and further refine suggestions.

The assistants may conduct research into various options for tasks 250. In an embodiment, the assistant may look into the location, time, and/or priority designation of one or more tasks, and provide suggestions for an order to complete the task 240. For example, if a first task is an appointment at a particular location, and a second task is located near the location of the first task, the one or more assistants may suggest completing the second task immediately after completion of the first task.

Once assistants 260a, 260b research options for task completion 250, the assistants may provide suggestions to complete tasks back to the application 240. The assistant suggestions may be presented to the user, who can, for example, use the suggestion, skip the suggestion, or provide feedback about the suggestion. If feedback is provided, assistants 260a, 260b may use the feedback in future research and suggestion determinations.

Task completion assistance may be further customized based on individual user preferences and user data. In an embodiment, users may be assigned an individual profile, in which they record and/or input tasks as described above. The user profile records user feedback, particular preferences, and may compile information regarding task type, data, timing, etc. User profiles may be password protected and accessible on one or more devices.

In an embodiment, the present invention may incorporate machine learning methods and utilize artificial intelligence to provide improved task-completion assistance suggestions to the user. For example, machine learning software may utilize and/or parse information available from an individual user's profile, to determine assistance suggestions. User input and feedback may assist in training the application, and determine user preferences, anticipate user tasks, tag one or more tasks, and provide personalized task-completion suggestions to the user.

Examples of user preferences and/or information, which machine learning and/or artificial intelligence algorithms may utilize, include, but are not limited to user interactions, interests, location, considered purchases, gifts, signals, tastes, habits, work, and family. Additional features and user information which may be incorporated and/or utilized into systems, methods, and applications of the present invention, include download and signup information, application integrated, added and imported tasks, task response time, task response and/or solution ratings, PS/MSA and member rating (e.g., per response, and tasks completed. These determinations can occur at one or more platforms and/or applications, including but not limited to IMV/MAP, the Shop Your Way platform, and other ecosystem applications.

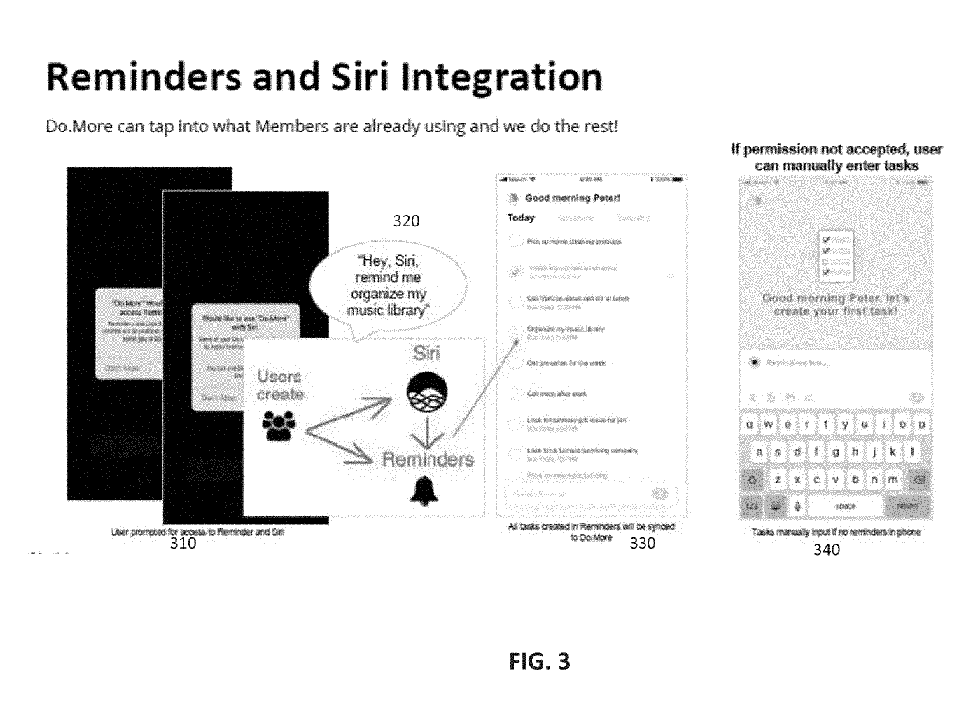

FIG. 3 illustrates an example embodiment utilizing third-party applications in accordance with aspects of the present invention. In the example embodiment, the iPhone application Siri may be incorporated to improve task management and assistance. In an embodiment, users may provide third-party applications access 310 to an application of the present invention, e.g., Do.More, and then create tasks using third-party applications, through various methods, like voice-activated instructions, reminders, recordings, and notes 320. With respect to the Siri application, users can provide an audio instruction about a task, e.g., a reminder to organize their music library. These instructions may create a reminder that will be synced to Do.More. In an embodiment, each reminder recorded in a third-party application may be synced with an application of the present invention, and tasks may be created based on those reminders. While the present example is specific to voice-recorded reminders using the Siri application, it will be appreciated that synced tasks are not limited to reminders, and may include other instructions and/or information from one or more applications. When reminders from third-party applications are synced with Do.More to create tasks 330, users can further edit the tasks and/or add additional tasks.

In another embodiment, third-party applications need not be enabled to work with a task suggestion and assistance application of the present invention. If permissions 310 are not granted for the Do.More application, for example, users can manually input reminders, tasks, or additional information directly into the Do. More application. From there, the application may proceed with task suggestions and assistance, as described above, with respect to FIG. 2.

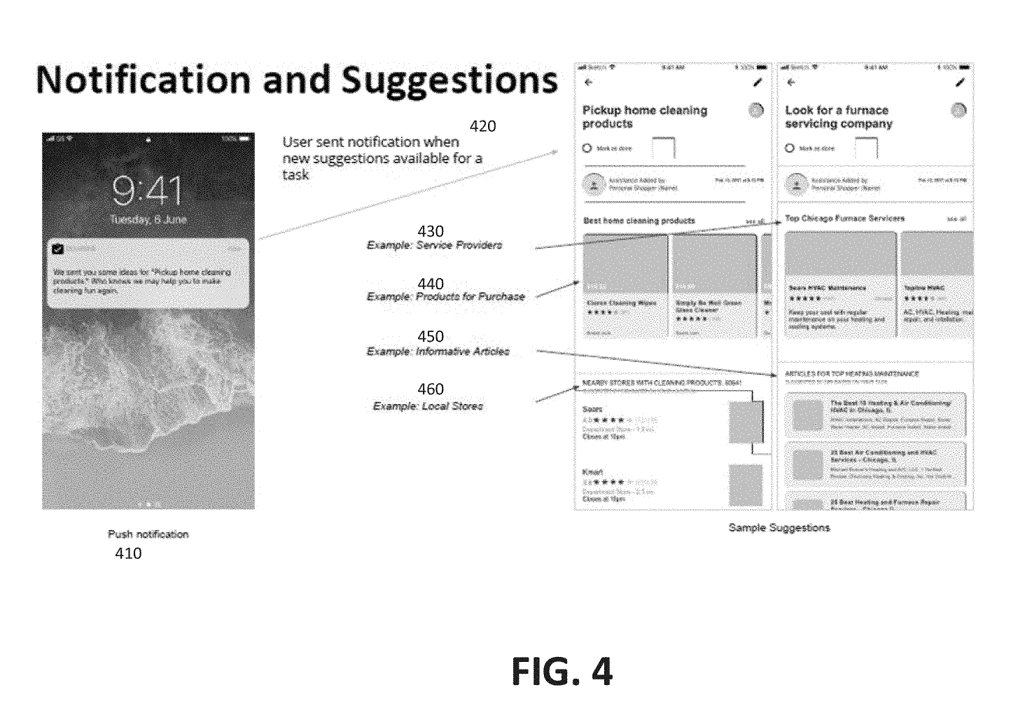

Turning to FIG. 4, an example notification for task suggestions are depicted. The notification may be a push notification 410 indicating the suggested task. The notification may occur immediately, upon determination of the task suggestion, when new suggestions are available for a task 420, or at another, scheduled point in time, such as the suggested time for the user to complete the task.

The notification may provide additional information suggesting one or more methods users can execute to accomplish the indicated task. For example, a notification regarding a “pickup home cleaning products” task may include one or more suggestions to complete the task. The notification may lead to one or more links to various websites regarding service providers 430, products for purchase 440, informative articles 450, and local stores 460. In an embodiment, the various websites, links, informative articles, and information from such sources may be compiled and/or displayed on the application's user interface. Additional task-suggestions examples include, but are not limited to relevant article links, purchase options, product research, curated reminder schedules, conversations, useful how-to's, deliveries, purchase fulfillment, DIY videos, and encouraging and inspirational messages.

Task-completion suggestions may be customized to the individual user, based on user preferences, user feedback, prior information, manual input, or information compiled from one or more sources, including third-party applications. Similarly, the arrangement of task-completion suggestions, as displayed to the user, may be customized for individual users.

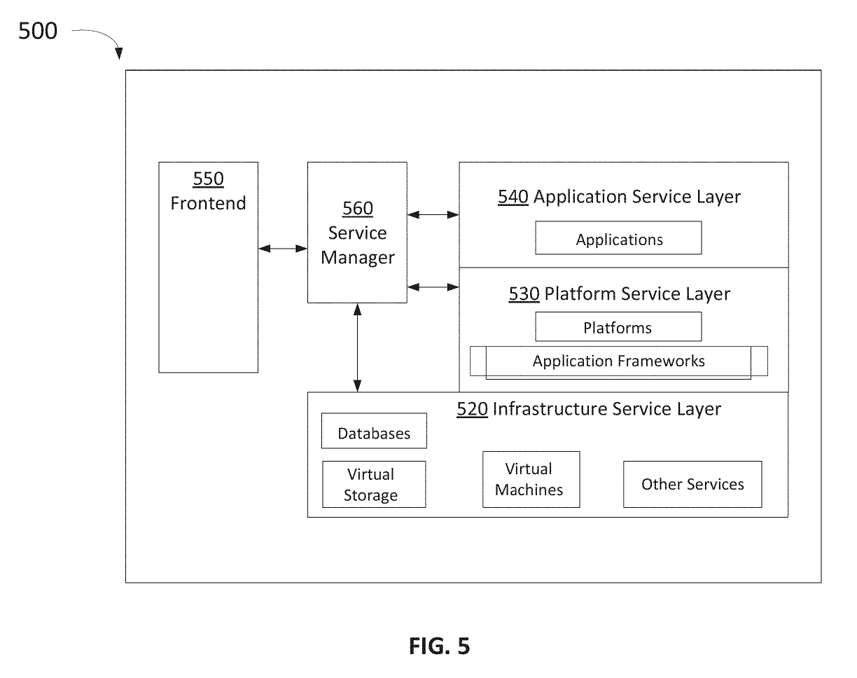

FIG. 5 is a schematic diagram illustrating an example cloud-based server 500 that may be used in accordance with the present disclosure. As discussed above with respect to FIG. 2, cloud-based server 500 may provide infrastructure services, platform services, and software application services. The infrastructure services may include virtualized resources, such as virtual machines, virtual storage, and so on. The infrastructure services may also include virtualized services, such as database services and others. Each of these infrastructure services may be deployed in an infrastructure service layer 520.

The scale and various aspects, such as data, connectivity, and dependency relationships within and between service components, of an infrastructure service deployment are configurable by an administrator user. For instance, the administrator user may submit a configuration specification to cloud-based server 500 via a frontend interface 550 and service manager 560. The configuration specification can be translated into infrastructure and kernel level APIs calls that create, re-create, move, or delete components such as virtual machines and services, and assign or change attributes of the components.

In addition to the infrastructure services, cloud-based server 500 may also provide platform services, such as an environment for running virtual machines or a framework for developing and launching a particular type of software applications. The platform services may be implemented in a platform service layer 530 over the infrastructure service layer 520, and may employ one or more infrastructure services configured in a particular manner. Configuration of platform services can be accomplished by program code written according to the APIs of the platform services and, optionally, the APIs of the infrastructure services that are employed in enabling the platform services.

In some examples, cloud-based server 500 may also provide software application services in an application service layer 540. A software application can be installed on one or more virtual machines or deployed in an application framework in the platform service layer 530. The software application can also communicate with one or more infrastructure service components, such as databases, in the infrastructure layer 520. The installation and configuration of the software application in the application service layer 540 can be accomplished through APIs of the software itself and the APIs of the underlying platform and infrastructure service components.

Depending on the type of services, a cloud-service user may be granted different levels of control in configuring the services. For example, if a software application service is employed, an administrator user is given control over how the software application is configured. If a platform service is employed, an administrative user is given control over how the platform and/or application frameworks are configured. Similarly, if infrastructure services are employed, an administrative user is given control over the particular infrastructure services employed.

The illustrations of the aspects described herein are intended to provide a general understanding of the structure of the various aspects. The illustrations are not intended to serve as a complete description of all of the elements and features of apparatus and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive. It is to be understood that the subject matter defined in the appended claims is not necessarily limited to the specific features or acts described above. Rather, the illustrations of the aspects described herein are intended as examples of implementing the claims and other equivalent features and acts are intended to be within the scope of the claims.

The techniques, or certain aspects or portions thereof, may, for example, take the form of program code (i.e., instructions embodied in tangible storage media or memory media implemented as storage devices, such as magnetic or optical media, volatile or non-volatile media, such as RAM (e.g., SDRAM, DDR SDRAM, RDRAM, SRAM, etc., ROM, etc., that may be included in computing devices or accessible by computing devices. When the program code is loaded into and executed by a machine, such as a computer, the machine becomes an apparatus for practicing the disclosure. In the case of program code execution on programmable computers, the computing device generally includes a processor, a storage medium readable by the processor (including volatile and non-volatile memory and/or storage elements, at least one input device, and at least one output device. One or more programs that may implement or utilize the processes described in connection with the disclosure, e.g., through the use of an application programming interface (API, reusable controls, or the like. Such programs are preferably implemented in a high level procedural or object oriented programming language to communicate with a computer system. However, the program(s can be implemented in assembly or machine language, if desired. In any case, the language may be a compiled or interpreted language, and combined with hardware implementations.

It should be understood that the various techniques described herein may be implemented in connection with hardware or software or, where appropriate, with a combination of both. The subject matter presented herein may be implemented as a computer process, a computer-controlled apparatus, a computing system, or an article of manufacture, such as a computer-readable storage medium. The terms “circuitry”, “component”, or “module” are used interchangeably throughout and include hardware components such as hardware interrupt controllers, hard drives, network adaptors, graphics processors, hardware based video/audio codecs, and the firmware used to operate such hardware. The terms “circuitry”, “component”, or “module” can also include microprocessors, application specific integrated circuits, and processors, e.g., cores of a multi-core general processing unit that perform the reading and executing of instructions, configured by firmware and/or software. Processor(s can be configured by instructions loaded from memory, e.g., RAM, ROM, firmware, and/or mass storage, embodying logic operable to configure the processor to perform a function(s.

In an example embodiment, where circuitry includes a combination of hardware and software, an implementer may write source code embodying logic that is subsequently compiled into machine readable code that can be executed by hardware. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

What is claimed:

1. A method for providing task management assistance for a user comprising:
receiving information indicative of at least one user task;
determining at least one task-completion suggestion, the task-completion suggestion comprising assistance information for completing the at least one user task; and
sending a notification to the user indicative of the task-completion suggestion.

2. The method of claim 1, wherein the task-completion suggestion is based on one or more of a type of task, user information, user feedback, task location, and a priority designation.

3. The method of claim 1, wherein the at least one task-completion suggestion is determined using at least one of: a personal assistant and an automated assistant.

4. The method of claim 1, wherein assistance information includes one or more of an informative article, a purchase option, a service provider, a reminder, advice, and a purchase suggestion.

5. The method of claim 1, wherein information indicative of a user task is received from at least one of a third-party application and user input.

6. The method of claim 1, wherein the task-completion suggestion determination utilizes machine learning methods.

7. The method of claim 1, further comprising queuing the at least one user task to determine an order for determining the task-completion suggestion.

8. The method of claim 7, wherein queueing is based on one more of an indicated priority, time, date, or user information of the task.

9. The method of claim 1, wherein the notification is a push notification.
